(19) United States
(12) Patent Application Publication
(10) Pub. No.: US 2011/0174391 A1
(43) Pub. Date: Jul. 21, 2011

(54) Repositioner

(76) Inventor: Charles L. Hawkins, Green Cove Springs, FL (US)

(21) Appl. No.: 12/381,286

(22) Filed: Mar. 10, 2009

(51) Int. Cl. F16K 43/00

(52) U.S. Cl. 137/315.01

(57) ABSTRACT

The repositioner described includes, in its preferred embodiment, 180-degree repositionable mounting plates with repositionable arms that move up and down, allowing for objects not exceeding 30,000 lbs and which can fit between the mounting plates. Included in the mounting plates are holes for connecting objects that require repositioning. Further included are lifting lugs for safely lifting and/or handling the repositioner as well as shipping ports for safely transporting the repositioner by a variety of methods. Another improvement is a provision for ridged, moisture barrier, non-corrosive cover that attaches to and seals against the repositioner frame. Another improvement involves a provision for repositioning that allows substantial improvement in the speed of repositioning and the safety in which the repositioning is applied to the object within the repositioner mounting plates.

### FEDERALLY SPONSORED RESEARCHED

Not Applicable.

### SEQUENCE LISTING OR PROGRAM

Not Applicable

### BACKGROUND

1. Field of Invention

This invention relates to a repositioner for, but not limited to, rotating and repositioning a aircraft carriers catapult low loss launch valve, a critical component of the launch process, as it is overhauled by manufacturing artisans.

2. Background and Summary

A conventional catapult low loss launch valve removal team consists of a minimum of one crane, two forklifts having 22 k lbs lifting capacity, four operators, two nylon slings, wooden pallets, dunnage and approximately 600 square foot of area for maneuvering. The aircraft carriers catapult low loss launch valve weighs approximately 13,000 lbs.

Post disassembly from the aircraft carriers steam system and post removal from within the aircraft carriers launch trough, now over the deck of the aircraft carrier, the valve is repositioned into the shipping position by repositioning 180-degrees from installed position using a crane, forklifts, slings and minimum four operators. This initial, precarious 180-degree repositioning of the valve while over the flight deck is where one source of additional costly damage to both the valve and flight deck can and does occurs.

Thus palletized and secured with dunnage and numerous shipping straps, the launch valve is minimized from movement during transportation to the repair facility. Unfortunately, prior wooden crates are neither easily transported nor offer the launch valve protection from moisture. Additionally, the crates lack a means of quick and safe fastening to the interior of a transportation vehicle or shipping container.

Once at the repair facility a minimum 600 square foot of floor area is cleared, a overhead crane, four operators and two forklifts are brought in, a special hoist attachment is connected from the crane and to the valve and the valve is lifted off of the wooden shipping crate. The valve then transferred to the forklifts from the crane, thus suspended in the air by the two opposing forklifts with nylon slings, and is disconnected from the crane. The forklifts begin to rise and to lower the attached valve suspended from the forks in a choreographed manner that repositions the valve 180-degrees from the shipping position. This is another precarious reposition maneuver of the valve where not only damage to the valve can and sometimes does occurs but also the repair teams safety is minimally compromised. The time for this repositioning of the launch valve into a position that is sufficient to perform repairs, once at the repair facility and post un-palletizing is 37 minutes.

Many of the drawbacks listed of such prior art devices are overcame by the development of my invention. One of the unique features of my repositioner is its repositioning arm assembly.

Using my invention a removal team, such as but not limited to, a aircraft carriers catapult low loss launch valve removal team will no longer need the many machines and operators once required. The removal team can now reposition the 13,000-pound launch valve with, one forklift and one operator and perform this repositioning in as little as 200 square foot.

My invention, primarily for but not limited to, aircraft carriers catapult low loss launch valve removal can also be used to reposition items that can be mounted between the mounting plates and do not exceed 30,000 pounds.

My invention's mounting plates settle the launch valve directly into a undercarriage after removal from the aircraft carriers launch trough negating the opportunity to further damage the valve and the aircraft carrier flight deck from human error during the removal and loading process. The carriage is located beneath the mounting plates, designed to immobilize the valve during shipping, and virtually eliminates shifting during transport by use of the inventions positive locking actuators.

My invention has fork lifting pockets incorporated into structural steel base frame, a corrosion resistant, ridged shipping cover that protects the object, such as but not limited to, launch valve. Additionally, said cover has a moisture gate breather and a gasket to seal the cover at the underside perimeter where said cover contacts the said base frame.

Another advantage of the present invention is repositioning objects without further damaging the object being repositioned.

### BRIEF DESCRIPTION OF THE DRAWINGS

FIG. 1 is a perspective view of the repositioner in accordance with the teachings of the invention with repositioner in the shipping position. Note: As a matter of national security, the low loss launch valve is not shown.

FIG. 2 is a perspective view of the repositioner in the installation position. Note: As a matter of national security, the low loss launch valve is not shown.

FIG. 3 is a perspective view of the invention with repositioner in the shipping position and the moisture barrier. Note: As a matter of national security, the low loss launch valve is not shown

### DETAILED DESCRIPTION

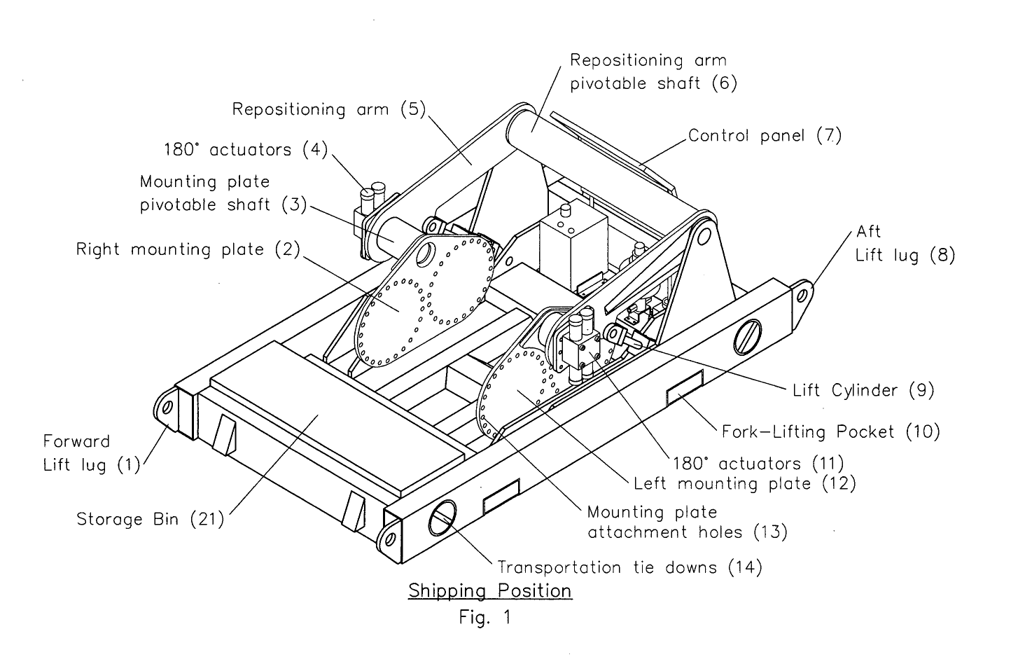

Turning first to FIG. 1 it will be seen that the repositioner produced in accordance with the teachings of this invention may be generally described as a frame supporting a control panel (7) and repositing arm pivotable shaft (6) contiguous a plurality of repositioning arms (5) connected to said arms are mounting plates (2 & 12), a plurality of 180-degree actuators (4 & 11) a plurality of lift cylinders (9). The base ends of said lift cylinders (9) are mounted to said frame and are contiguous to said repositing arm (5). Said repositing arms are pivotable around the said pivotable shaft (6). Parallel and opposite the said repositing arm pivotable shaft is sandwiched a plurality mounting plate pivotable shaft (3) Said shaft is sandwiched by one of said plural mounting plates proximate the inside of the repositioner arm and one of the plural 180-degree actuators (4) proximate the outside of the repositoner. Said lift cylinders (9) and said 180-degree actuators (4 & 11) are connected, but not limited to hydraulically, to said control panel (7). Left mounting plate (12) and right mounting plate (2) contain a series of holes for mounting such as, but not limited to, a aircraft carriers catapult low loss launch valve. The mounting plates (2 & 12), as well as the repositing arms (5) are shown in the shipping position.

Protruding from and proximate the forward and aft end of the repositioner frame, port and starboard of centerline are a plurality of, but not limited to, lifting lugs, forward lift lugs (1) and aft lift lugs (8). In addition, internal and proximate port and starboard of the repositioner frame, forward and aft of centerline are a plurality of transportation tie-downs (14) for use, but not limited to, aircraft transportation. Furthermore, situated port to starboard, forward and aft of centerline a plurality fork-lifting pocket (10)

However, numerous variations are possible without deviating from and/or exceeding the spirit and scope of the inventive concept. Moreover, many of the above disclosed and other features and functions, or alternatives thereof, may be desirably combined into various other different systems or applications. In addition, numerous presently unforeseen or unanticipated alternatives, modifications, variations or improvements therein may be subsequently made by those skilled in the art which are also intended to be encompassed by the claims that follow.

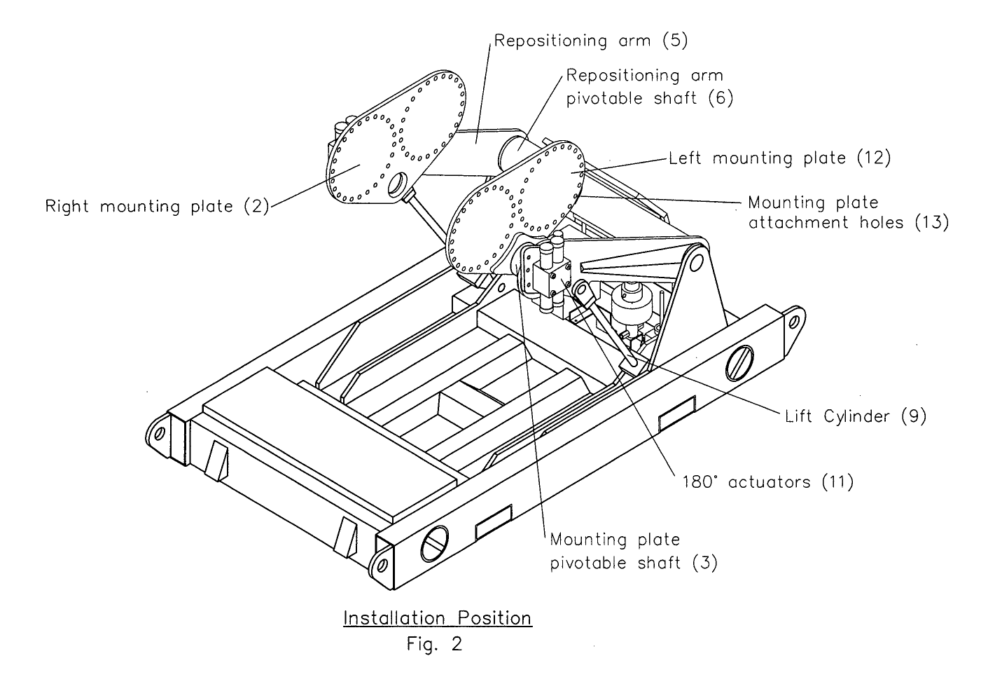

Turning next to FIG. 2, it can be seen that the plural lift cylinder (9) are extended thus rotating the repositing arms (5) about the repositing arm pivotable shaft (6); subsequently the plural mounting plates (2 & 12) are repositioned 180-degrees pivotably previously said mounting plate pivotable shaft (3) by means of the plural 180-degree actuators (11).

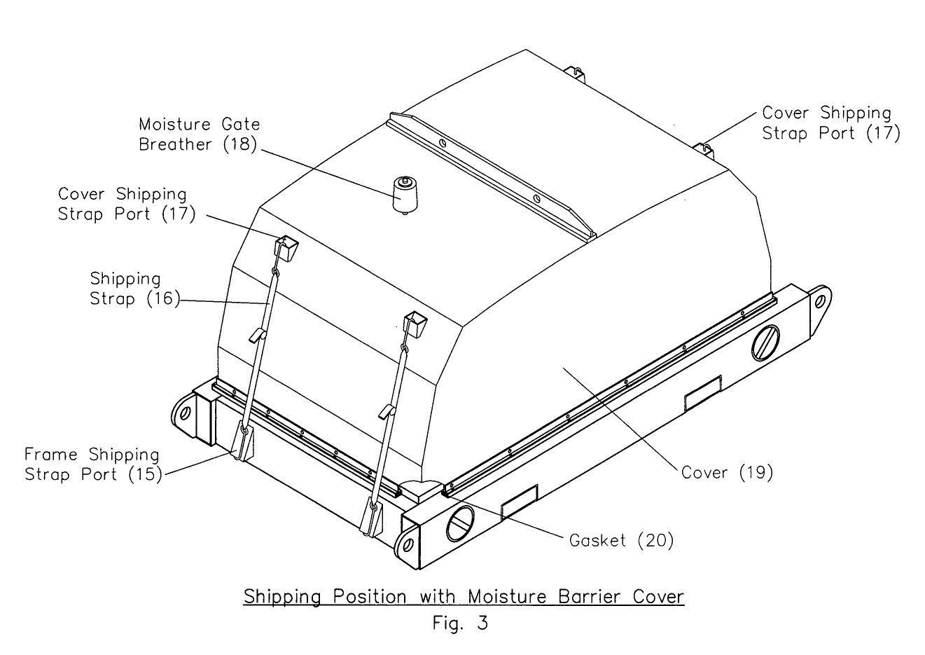

Turning next the FIG. 3 a moisture barrier cover (19) can be seen wholly protecting the repositioner moving parts and such as, but not limited to, a enclosed launch valve from the elements. Said cover has a moisture gate breather (18) that restricts air containing moisture from entering interior said cover. Also, forward and aft of both said cover and said repositioner frame, port and starboard of centerline are plurality of cover shipping strap ports (17) and plurality of frame shipping strap ports (15), said ports are vertically aligned and shipping straps (16) join said cover to said frame. A gasket (20) located along the underside perimeter of the cover, seal said cover to said frame.

Furthermore, a self-contained, tool storage bin (21) is affixed proximate the forward end of the repositioner. The said tool bin contains a visual indicator for indicating when a tool or item of the repositioners hardware, for example but not limited to, draft pins, pneumatic wrenches, are missing.

Finally, the following parts list for the drawing figures may be found to be of assistance in understanding more fully the concepts on my invention. Shown on FIG. 1 are items numbered 1 through 14 & item numbered 21. Shown on FIG. 3 are numbers 15 through 20.
1. Forward lifting lug.
2. Right mounting plate.
3. Mounting plate pivotable shaft.
4. 180-degree actuator.
5. Repositioning arm(s).
6. Repositioning arm pivotable shaft.
7. Control panel.
8. Aft lift lug(s).
9. Lift cylinder(s).
10. Fork-lifting pocket(s)
11. 180-degree actuator.
12. Left mounting plate.
13. Mounting plate attachment holes.
14. Transportation tie downs.
15. Frame shipping strap port.
16. Shipping strap.
17. Cover shipping strap port.
18. Moisture gate breather.
19. Cover.
20. Gasket.
21. Tool storage bin.

What is claimed is:

1. I claim the ability to reposition, such as but not limited to, a aircraft carriers catapult low loss valve, quickly for repairs and maintenance.

2. In claim 1, the ability to reposition, such as but not limited to, a aircraft carriers catapult low loss valve, safely for repairs and maintenance.

3. In claim 2, the ability to protect, such as but not limited to, a aircraft carriers catapult low loss valve, from the elements during shipping.

4. In claim 3, the ability to protect, such as but not limited to, a aircraft carriers catapult low loss valve, from the elements during storage.

5. In claim 4, the ability to minimize additional damage to, such as but not limited to, a aircraft carriers catapult low loss valve, during repositioning.
